(19) United States
(12) Patent Application Publication
(10) Pub. No.: US 2011/0057806 A1
(43) Pub. Date: Mar. 10, 2011

(54) Hazardous Condition Detector with Hardware Hush

(75) Inventor: Eric V. Gonzales, Aurora, IL (US)

(73) Assignee: UNIVERSAL SECURITY INSTRUMENTS, INC, Owing Mills, MD (US)

(21) Appl. No.: 12/877,611

(22) Filed: Sep. 8, 2010

Related U.S. Application Data
(60) Provisional application No. 61/240,770, filed on Sep. 9, 2009.

(51) Int. Cl. G08B 17/10

(52) U.S. Cl. 340/628

(57) ABSTRACT

A hazardous condition detector including a housing containing at least one sensor unit for sensing at least one ambient condition and a microprocessor contained within the housing operatively coupled to the sensor unit though a hardware interface. The hazardous condition detector also includes a memory means associated with the microprocessor, the memory means contains at least one alarm threshold value stored therein from which the microprocessor selects a single alarm threshold value, and user activated hardware control means operatively coupled to the microprocessor. The control means when activated by a user during an alarm condition reduces the sensitivity of the hazardous condition detector by changing the voltage across the sensor unit sensed by the microprocessor to a level that is within the range of a non alarm event defined by the single alarm threshold value selected by the microprocessor. During normal operation of the hazardous condition detector and during the hazardous condition detector's operation with reduced sensitivity, the hazardous condition detector employs the same alarm threshold value.

### PRIORITY CLAIM

This application claims the benefit of U.S. Provisional Application Ser. No. 61/240,770 filed on 9 Sep. 2009 which is incorporated herein by reference.

### FIELD OF THE INVENTION

This invention relates to the field of hazardous condition detectors in general and specifically to a hazardous condition detector featuring a one button hush feature.

### BACKGROUND OF THE INVENTION

Fire detection devices are such as smoke detectors and/or gas detectors are generally employed in structures or machines monitor the environmental conditions within the living area or occupied compartments of a machine and will provide an audible warning upon detection of a change in environment conditions that are generally accepted as a precursor to a fire event.

Generally, smoke detectors include a smoke sensing chamber, exposed to the atmosphere of interest. The smoke detector's smoke sensing chamber is coupled to a microprocessor circuit. The smoke sensor samples the qualities of the exposed atmosphere and when a change in the atmosphere of the exposed chamber is detected by the microprocessor, a alarm is sounded.

A variety of optical gas sensors for detecting the presence of hazardous gases, especially carbon monoxide (“CO”), are known.

Generally, optical gas sensors include a self-regenerating, chemical sensor reagent impregnated into or coated onto a semi-transparent substrate. The substrate is typically a porous monolithic material, such as silicon dioxide, aluminum oxide, aluminosilicates, etc. Upon exposure to a predetermined target gas, the optical characteristics of the sensor change, either darkening or lightening depending on the chemistry of the sensor.

Smoke and gas sensors can be affected by temperature, humidity, and dust particles. One or a combination of these ambient factors can cause a smoke or gas detector to false alarm.

When a hazardous condition detector issues a false alarm due to a change in on one or more ambient conditions that typically indicates a fire hazard but in a particular instance does not indicate an immediate fire hazard, for example a smoking pot on a stove in a kitchen or cigar smoke in a room being monitored by a smoke detector, Instead, the source of the detected smoke may be under the control of the occupant as, for example, in the situation where the occupant may be cooking in the kitchen.

In such and other situations the sounding of the smoke detector alarm becomes more of an annoyance than a help. To accommodate consumer desires to silence the alarm in such situations, while at the same time maintaining functionality of the smoke detector, a hush feature was introduced into conventional smoke detector design.

Prior solutions to the inadvertent sounding of a smoke detector or hazardous condition alarm include implementing a hush feature to the smoke detector. Such a hush feature operates in conventional ASIC-based smoke detectors to reduce the sensitivity of the smoke detectors so that the smoke resulting from consumer-controlled conditions do not result in the sounding of the smoke detector alarm. In such a reduced sensitivity mode of operation, the conventional ASIC-based smoke detectors will sound an alarm if a level of smoke sensed continues to increase beyond the reduced sensitivity level. In this way, the consumers will again be provided with an audible warning indicating that the level of smoke within their dwelling has continued to increase since the hush feature was initiated.

Other solutions include employing a microprocessor to store two alarm levels for alarm and hush. When their detector alarms and the hush button is pressed, a second alarm threshold is assigned by the microprocessor. The detector will eventually alarm if there is a persistence of smoke or fire condition.

Since the microprocessor has limited available memory, an alternative hush feature that does not use the limited memory of the microprocessor is needed.

### SUMMARY OF THE INVENTION

It is an object of the present invention to provide means to easily and efficiently silence a hazardous condition detector when an alarm condition is detected but in a particular instance does not indicate an immediate fire hazard.

It is another object of the present invention to provide a hazardous condition detector featuring a one button hush feature.

It is yet another object of the present invention to provide a hush feature that is easily implemented in a hazardous condition detector.

It is another object of the present invention to provide a hush feature that minimizes the additional load on the processing resources of the hazardous condition detector.

It is still another object of the present invention to provide a hush feature that is implemented substantially through the hazardous condition detector's hardware.

These and other objects are accomplished in part via a hazardous condition detector that includes a housing containing at least one sensor unit for sensing at least one ambient condition, a microprocessor contained within the housing operatively coupled to the sensor unit though a hardware interface and a memory means associated with the microprocessor. The memory means also contains a single alarm threshold value stored therein. The hazardous condition detector also contains a user activated control means operatively coupled to the microprocessor for reducing the sensitivity of said hazardous condition detector. During normal operation of the hazardous condition detector and during the hazardous condition detector's operation in a reduced sensitivity mode, the hazardous condition detector employs the same alarm threshold value.

Other objects are satisfied by the disclosed is a hazardous condition detector including a housing containing at least one sensor unit for sensing at least one ambient condition and a microprocessor contained within the housing operatively coupled to the sensor unit though a hardware interface. The hazardous condition detector also includes a memory means associated with the microprocessor, the memory means contains at least one alarm threshold value stored therein from which the microprocessor selects a single alarm threshold value, and user activated hardware control means operatively coupled to the microprocessor. The control means when activated by a user during an alarm condition reduces the sensitivity of the hazardous condition detector by changing the voltage across the sensor unit sensed by the microprocessor to a level that is within the range of a non alarm event defined by the single alarm threshold value selected by the microprocessor. During normal operation of the hazardous condition detector and during the hazardous condition detector's operation with reduced sensitivity, the hazardous condition detector employs the same alarm threshold value.

Yet other objects are achieved by the disclosed method for reducing the sensitivity of hazardous condition detector including sensing at least one ambient condition with an ambient condition sensor and detecting the voltage across the ambient condition sensor with a microprocessor. The method also includes storing at least one alarm threshold value in a memory device coupled to the microprocessor, and selecting a single alarm threshold value as the current alarm threshold where the single alarm threshold value defines the limits of a range of current non alarm conditions. The method also includes entering into an alarm mode when the voltage across the ambient condition sensor detected by the microprocessor is within the range of alarm event conditions defined by the current alarm threshold. The method also includes receiving a signal when the hazardous condition detector is in the alarm mode from a user through a user activated control means operatively coupled to the microprocessor to enter a reduced sensitivity mode. The method also includes reducing the sensitivity of the hazardous condition detector with an electrical circuit by altering the voltage across the ambient condition sensor detected by the microprocessor to a level that is outside the range of an alarm event conditions defined by single selected alarm threshold value.

As used herein “substantially,” “generally,” and other words of degree are relative modifiers intended to indicate permissible variation from the characteristic so modified. It is not intended to be limited to the absolute value or characteristic which it modifies but rather possessing more of the physical or functional characteristic than its opposite, and preferably, approaching or approximating such a physical or functional characteristic.

### BRIEF DESCRIPTION OF THE DRAWINGS

FIG. 1 illustrates front view of an example embodiment of a hazardous condition detector system.

FIG. 2 illustrates an example embodiment of the circuit for the hardware hush feature of the instant invention.

FIG. 3 illustrates a hazardous condition detector system of FIG. 1 employing an embodiment of the hardware hush feature shown in FIG. 2.

### DETAILED DESCRIPTION

Disclosed is an innovative new hush feature for a hazardous condition detector that does not require the storage of multiple alarm threshold values in the microprocessor. The new method employs a hardware solution that allows the hazardous condition detector to employ a single alarm threshold for multiple alarm conditions. The single alarm threshold condition is used for the initial alarm condition, and as the alarm threshold for a subsequent alarm while in the hush mode.

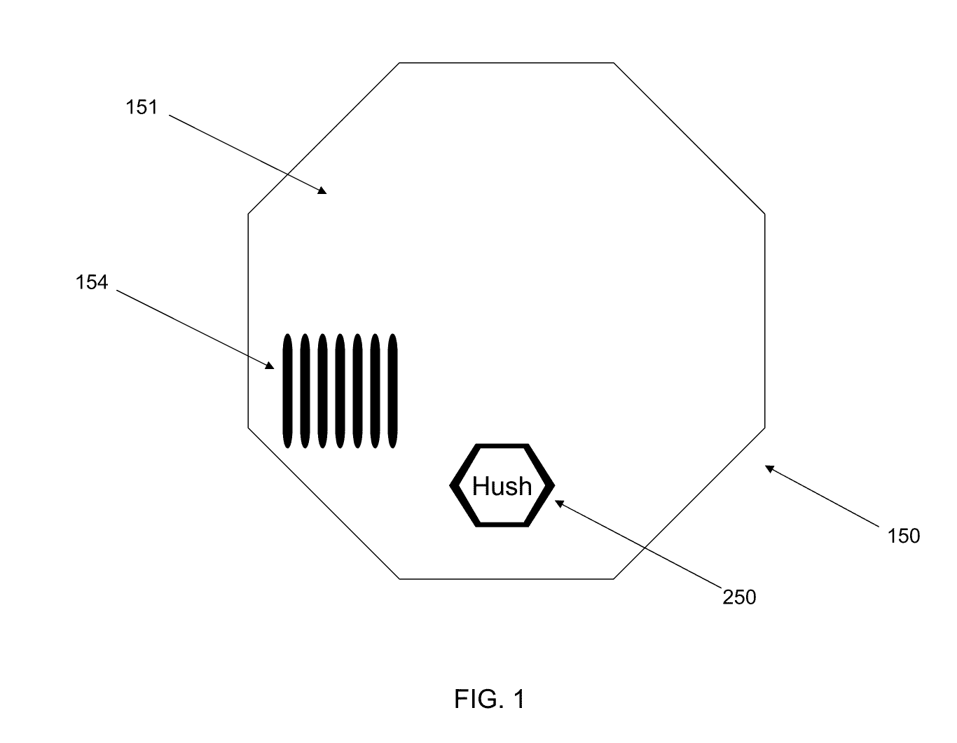

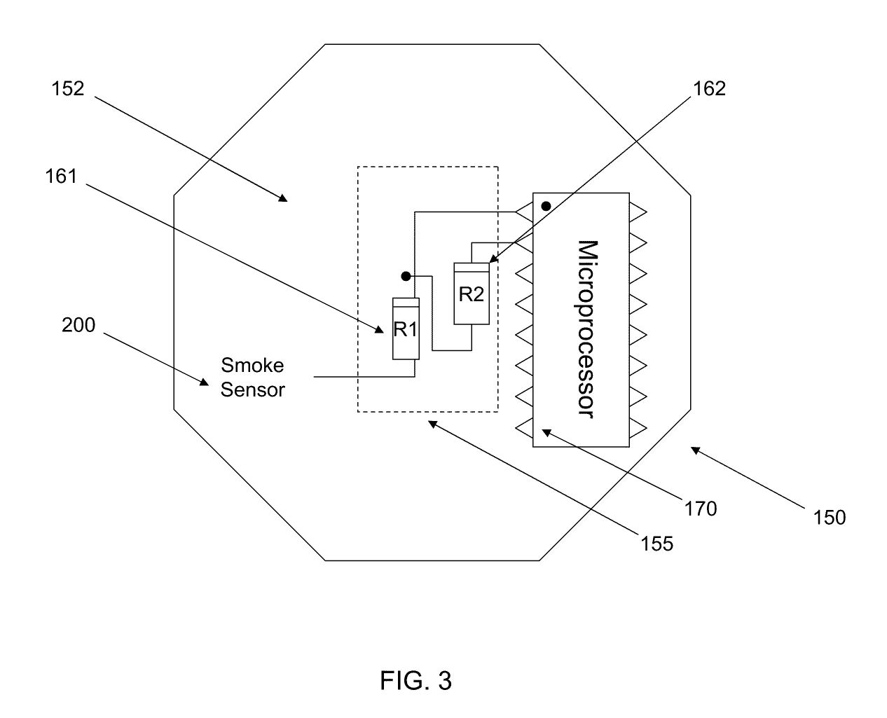

With reference now to the figures where like reference numbers denote like elements, FIG. 1 illustrates a front view of an example embodiment of a hazardous condition detector system with a hush mode. FIG. 3 illustrates an example embodiment of the hardware hush feature of the instant invention incorporated into the hazardous condition detector shown in FIG. 1.

As shown in FIGS. 1 and 3 the hazardous condition detector 150 includes a housing having a housing cover 151 to cover and protect the internal electronics. The housing cover 151 incorporates a hush button 250 coupled to hazardous condition detector's microprocessor 170. The housing cover also incorporates an environmental vent assembly 154 which is disposed proximate to the sensor unit 200 or sensor package through which the sensor is exposed to and collects readings from the ambient environment.

Referring now to FIG. 3 the exemplarily embodiment of the hazardous condition detector 150 contains at least one sensor unit 200 for sensing at least one ambient condition such as smoke or the levels of hydrocarbons in the ambient environment, and a microprocessor 170 contained within the housing 151. The microprocessor 170 is operatively coupled to the sensor 200 though the hardware interface 155.

The hazardous condition detector 150 also includes a memory means associated with the microprocessor (not shown). The memory means may be a memory device resident on or in the microprocessor 170, or it may be disposed on another chip coupled to the microprocessor 170. The memory device comprising the means consist of non-volatile memory, and contains at least one alarm threshold value stored therein. The memory device may also feature volatile memory or be a combination of both volatile and non-volatile types of memory.

The hazardous condition detector also includes a user activated control means operatively coupled to the microprocessor 170 for reducing the sensitivity of the hazardous condition detector 150. The control means is typically a hush button 250 and may include the hardware hush circuit 155. The control means is activated with a hush button 250 that is preferably disposed on the housing 151 and accessible to the user. When the user depresses the hush button 250 the microprocessor activates the hardware hush circuit 155. Typically the user activated control means employs a single button, or other switch, however it may be a combination of buttons coupled to the hardware hush circuit through the microprocessor 170.

During normal operation of the hazardous condition detector 150 the microprocessor 170 selects and employs an alarm threshold value defining the onset of a fire or other hazardous condition. When the hazardous condition detector's microprocessor senses, through the sensor package, an ambient condition beyond the threshold value defining the onset of a hazardous condition, the hazardous condition detector goes into an alarm mode and issues a hazardous condition alarm warning. The alarm warning may be visual, audible or a combination of both. If this alarm mode is a result of a known condition an operator can activate the hardware hush circuit via depressing the hush button, hushing the alarm and causing the detector to enter into a reduced sensitivity mode.

The hardware hush circuit 155, when activated causes the detector 150 to enter into a reduced sensitivity mode effectively taking the hazardous condition detector out of the alarm mode. The hardware hush circuit 155 accomplishes this by altering or manipulating the output of the sensor unit 200 as sensed by the microprocessor 170. The hazardous condition detector's microprocessor 170 employs the same alarm threshold value in both the reduced sensitivity mode and in the normal alarm mode.

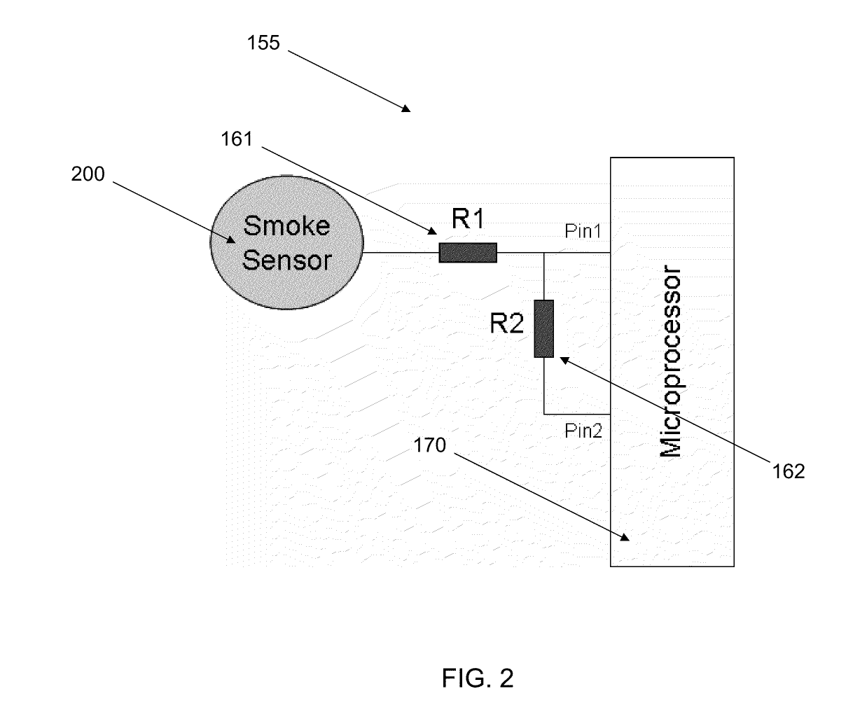

FIG. 2 illustrates an example embodiment of the hardware hush circuit 155. With reference to FIG. 2 the hardware hush circuit 155 includes a resistor R1 161 disposed between the smoke sensor 200 and pin1 171 of the microprocessor 170. The microprocessor 170 senses the change in the voltage across the sensor package 200 through pin1 171. In the hardware hush circuit, pin1 171 of the microprocessor 170 is coupled to pin2 172 of the microprocessor 170 through a second resistor R2 162. Pin1 171 of the microprocessor 170, R1 161 and R2 162 share a common node. Under normal conditions, prior to activation of the hardware hush pin2 172 of the microprocessor 170 is high impedance (input only). This causes the resulting voltage on pin1 171 of the microprocessor 170 to approach 100% of the voltage output of the smoke sensor 200. The microprocessor 170 employs the voltage reading from the sensor package 200 as received on pin1 171 to determine whether or not to enter into an alarm mode.

When the detector 150 goes into an alarm mode and the hush button is depressed, the microprocessor 170 brings pin2 172 high to increase the voltage on pin1 170. The effect of bringing pin2 172 to a particular level, which takes the sensor output as detected on pin1 171 out of an alarm condition and ultimately takes the detector out of alarm mode. The manipulation of the voltage across pin1 171 hushes the detector until 150 the level of smoke is high enough to re-trigger the alarm even with the voltage manipulation from pin2 172. If the level of smoke continues to increase the resulting voltage across pin1 161 continues to increase until the microprocessor again senses an alarm condition and reenters the alarm mode.

In other embodiments, depending on the configuration of the sensor, microprocessor 170 may cause pin2 172 to go into a low condition when the hardware hush circuit is activated. This reduces the voltage detected on pin1 171 lowering the voltage. If the sensor is configured to detect hazardous conditions such as smoke based on an increasing voltage, microprocessor manipulates the sensor output by forcing pin2 172 low to take the detector out of an alarm condition. If the sensor alarms based on a decreasing voltage pin2 172 is forced high by the microprocessor to take the detector out of an alarm condition. The decision whether to place pin2 172 to either high or low ultimately depends on the configuration of the sensor, but the aggregate effect is to bring pin2 172 to a particular level, which manipulates the voltage on pin1 and takes sensor output of an alarm condition and ultimately takes the detector out of alarm mode.

In yet another embodiment the invention resides in a method for reducing the sensitivity of a hazardous condition detector 150 by sensing at least one ambient condition with an ambient condition sensor, and detecting the voltage across the ambient condition sensor with a microprocessor 170. The method also includes storing at least one alarm threshold value in a memory device coupled to the microprocessor 170, and selecting a single alarm threshold value as the current alarm threshold where the single alarm threshold value defines the limits of a range of current non alarm conditions. The method also includes entering into an alarm mode when the voltage across the ambient condition sensor detected by the microprocessor is within the range of an alarm event as defined by the current alarm threshold.

The method also includes receiving a signal when the hazardous condition detector is in the alarm mode from a user through a user activated control means operatively coupled to the microprocessor to enter a reduced sensitivity mode. The method also includes reducing the sensitivity of the hazardous condition detector with an electrical circuit by altering the voltage across the ambient condition sensor detected by the microprocessor to a level that is outside the range of an alarm event conditions defined by single selected alarm threshold value. The method may reduce the sensitivity of the hazardous condition detector by reducing or increasing the voltage across the ambient condition sensor detected by the microprocessor depending on the configuration of the hazardous condition detector's sensor package.

As shown through the above discussed embodiments the disclosed hardware hush only requires the microprocessor to employ a single alarm threshold for both the normal and reduced sensitivity hush modes, thus freeing processing and memory resources for other smoke detector task such as interconnect management, alarm discrimination or other features that require the use of the microprocessor's memory resources.

In other embodiments the duration of the reduced sensitivity mode is governed by a timing circuit. The timing circuit may be in a hardware embodiment such as an RC circuit that uses the charging or discharging of a capacitor to determine the duration of the reduced sensitivity mode, or it may be in the form of software or firmware using the microprocessor or ASIC for setting the duration of the reduced sensitivity mode.

Although specific example embodiments have been illustrated and described herein, those of ordinary skill in the art appreciate that other variations, aspects, or embodiments may be contemplated, and/or practiced without departing from the scope or the spirit of the appended claims.

1. A hazardous condition detector comprising:
a housing containing at least one sensor unit for sensing at least one ambient condition,
a microprocessor contained within said housing operatively coupled to said sensor unit though a hardware interface;
a memory means associated with said microprocessor, said memory means containing a single alarm threshold value stored therein;
a user activated control means operatively coupled to said microprocessor for reducing the sensitivity of said hazardous condition detector;
wherein during normal operation of said hazardous condition detector and during said hazardous condition detector's operation in a reduced sensitivity mode, said hazardous condition detector employs the same alarm threshold value.

2. A hazardous condition detector comprising:
a housing containing at least one sensor unit for sensing at least one ambient condition,
a microprocessor contained within said housing operatively coupled to said sensor unit though a hardware interface;
a memory means associated with said microprocessor, said memory means containing at least one alarm threshold value stored therein from which said microprocessor selects a single alarm threshold value;
a user activated hardware control means operatively coupled to said microprocessor wherein said control means when activated by a user during an alarm condition reduces the sensitivity of the hazardous condition detector by changing the voltage across the sensor unit sensed by the microprocessor to a level that is within the range of a non alarm event defined by said single alarm threshold value selected by said microprocessor;
wherein during normal operation of said hazardous condition detector and during said hazardous condition detector's operation with reduced sensitivity, said hazardous condition detector employs the same alarm threshold value.

3. A hazardous condition detector of claim 2 wherein said control means when activated during an alarm condition reduces the sensitivity of the hazardous condition detector by reducing the voltage across the sensor unit sensed by the microprocessor.

4. A hazardous condition detector of claim 2 wherein said control means when activated during an alarm condition reduces the sensitivity of the hazardous condition detector by increasing the voltage across the sensor unit sensed by the microprocessor.

5. A method for reducing the sensitivity of hazardous condition detector comprising:
sensing at least one ambient condition with a ambient condition sensor,
detecting the voltage across said ambient condition sensor with a microprocessor;
storing a single alarm threshold value in a memory device coupled to said microprocessor, said single alarm threshold value defining the limits of a range of non alarm conditions;
entering into an alarm mode when the voltage across the ambient condition sensor detected by the microprocessor is within the range of alarm event conditions defined by said single alarm threshold;
receiving a signal when the hazardous condition detector is in the alarm mode from a user through a user activated control means operatively coupled to said microprocessor to enter into a reduced sensitivity mode; and
reducing the sensitivity of said hazardous condition detector with an electrical circuit by altering the voltage across the ambient condition sensor detected by the microprocessor to a level that is outside the range of an alarm event conditions defined by said single alarm threshold.

6. The method of claim 5 further comprising the step of reducing the sensitivity of the hazardous condition detector by reducing the voltage across the ambient condition sensor detected by the microprocessor.

7. The method of claim 5 further comprising the step of reducing the sensitivity of the hazardous condition detector by increasing the voltage across the ambient condition sensor detected by the microprocessor.
